(19) United States
(12) Patent Application Publication
(10) Pub. No.: US 2016/0197433 A1
(43) Pub. Date: Jul. 7, 2016

(54) WATERPROOF RECEPTACLE CONNECTOR

(71) Applicant: LS MTRON LTD., Gyeonggi-do (KR)

(72) Inventors: Jung-Hoon CHOI, Seoul (KR); Kyung-Hae CHOI, Suwon-si (KR); Dong-Hee KIM, Suwon-si (KR)

(21) Appl. No.: 14/909,960

(22) PCT Filed: Aug. 6, 2014
(86) PCT No.: PCT/KR2014/007288

§ 371 Date: Feb. 3, 2016

(30) Foreign Application Priority Data
Aug. 7, 2013 (KR) 10-2013-0093632

(51) Int. Cl. H01R 13/52

(52) U.S. Cl. CPC H01R 13/5202

(57) ABSTRACT

A waterproof receptacle connector includes: a plurality of contacts, a support plate for partially covering and protecting the contacts, an insulator on which the contacts are installed; and a shell for containing the insulator on which the contacts are installed, wherein the shell has upper, lower, left, and right surfaces processed with no holes or pores, except for a front surface portion through which a plug connector is inserted and a rear surface portion through which the insulator is inserted, and, after the insulator is inserted through the rear surface portion of the shell, an interruption portion may be formed on the rear surface.

### TECHNICAL FIELD

The present disclosure relates to a receptacle connector, and more particularly, to a receptacle connector with a waterproofing structure.

The present application claims priority to Korean Patent Application No 10-2013-0093632 filed in the Republic of Korea on Aug. 7, 2013, the disclosure of which is incorporated herein by reference.

### BACKGROUND ART

Generally, electronic devices including mobile phones, digital cameras and PDAs are electrically connected to other electronic devices through a connector to transmit data including images and audios, or connected to a charger to enable their charging. The connector generally includes a plug connector and a receptacle connector that is coupled with the plug connector. The receptacle connector is mounted in an electronic device and fixed on a printed circuit board (PCB) of the electronic device. Also, when the plug connector is coupled with the receptacle connector, the plug connector is electrically connected to the electronic device and a data transmission or electricity charging function is enabled.

A type of connector device being widely used in recent days is a micro-USB.

A conventional receptacle connector includes a contact assembly of five contacts formed in an insulator by insert molding and a shell made of metal surrounding the insulator.

However, the conventional receptacle connector may cause a malfunction in a mobile electronic device in the event that water enters the mobile electronic device through a hole formed in the shell in which the insulator is received or a gap created when the insulator and the shell are assembled together.

Also, up-to-date mobile electronic devices including mobile phones have a tendency for a separate dust cap to gradually disappear from a case. Accordingly, there is a need for improvements in a function for preventing water from entering a mobile electronic device through a receptacle connector.

### RELATED LITERATURES

(Patent Literature 1) Japanese Unexamined Patent Publication No. 2012-059381 (Mar. 22, 2012)

### DISCLOSURE

### Technical Problem

The present disclosure is designed to solve the problem such as above, and therefore, the present disclosure is directed to providing a waterproof receptacle connector with an improved structure of the receptacle connector to prevent water from entering a mobile electronic device.

These and other objects and advantages of the present disclosure may be understood from the following detailed description and will become more fully apparent from the exemplary embodiments of the present disclosure. Also, it will be easily understood that the objects and advantages of the present disclosure may be realized by the means shown in the appended claims and combinations thereof.

### Technical Solution

To achieve the object such as above, a waterproof receptacle connector according to one aspect of the present disclosure includes a plurality of contacts, a support plate for partially covering and protecting the contacts, an insulator on which the contacts are installed, and a shell for containing the insulator on which the contacts are installed, wherein the shell has upper, lower, left, and right surfaces processed with no hole or pore, except for a front surface portion through which a plug connector is inserted and a rear surface portion through which the insulator is inserted, and after the insulator is inserted through the rear surface portion of the shell, an interruption portion is formed on the rear surface.

The shell may be processed by a die casting method.

The shell may be processed by a metal injection molding (MINI) method.

The shell may include a holddown integrally formed with the shell and branched off on both sides of a bottom where contact with a printed circuit board takes place.

The interruption portion may be formed by potting the rear surface after the insulator is inserted into the shell.

The shell may have a rectangular shape when viewed from a direction in which the plug connector is inserted.

### Advantageous Effects

According to one aspect of the present disclosure, when a shell is embodied via die casting or metal injection molding, the shell has no hole or pore on the upper, lower, left, and right surfaces, except a front surface portion through which a plug connector is inserted and a rear surface portion through which an insulator is inserted. Thus, penetration of water into a product can be prevented. Also, potting the rear surface of the insulator after coupled with the shell can prevent the ingress of water through a gap created by combining the two components.

According to another aspect of the present disclosure, the receptacle connector can provide a waterproofing function by its structure. Also, the receptacle connector eliminates the need for a separate waterproofing means such as a dust cap or a housing, so the receptacle connector has effects on component cost and task resource savings and a reduced mounting height of a product.

### BRIEF DESCRIPTION OF THE DRAWINGS

The accompanying drawings illustrate a preferred embodiment of the present disclosure and together with the foregoing disclosure, serve to provide further understanding of the technical spirit of the present disclosure, and thus, the present disclosure is not construed as being limited to the drawing.

FIG. 1 is an exploded perspective view of a waterproof receptacle connector according to an embodiment of the present disclosure.

FIG. 2 is an assembled perspective view of a waterproof receptacle connector according to an embodiment of the present disclosure.

FIG. 3 is a cross-sectional view of FIG. 2 taken along the line II-ff.

### MODE FOR CARRYING OUT THE INVENTION

Hereinafter, preferred embodiments of the present disclosure will be described in detail with reference to the accompanying drawings. Prior to the description, it should be understood that the terms or words used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the embodiments described in the specification and elements illustrated in the drawings are just a preferable example for the purpose of illustrations only, not intended to limit the scope of the disclosure, so it should be understood that other equivalents and modifications could be made thereto at the time of filing the application.

Also, in the description of the present disclosure, when it is deemed that a certain detailed description of related known functions or elements may unnecessarily render the essence of the disclosure ambiguous, their detailed description is omitted herein.

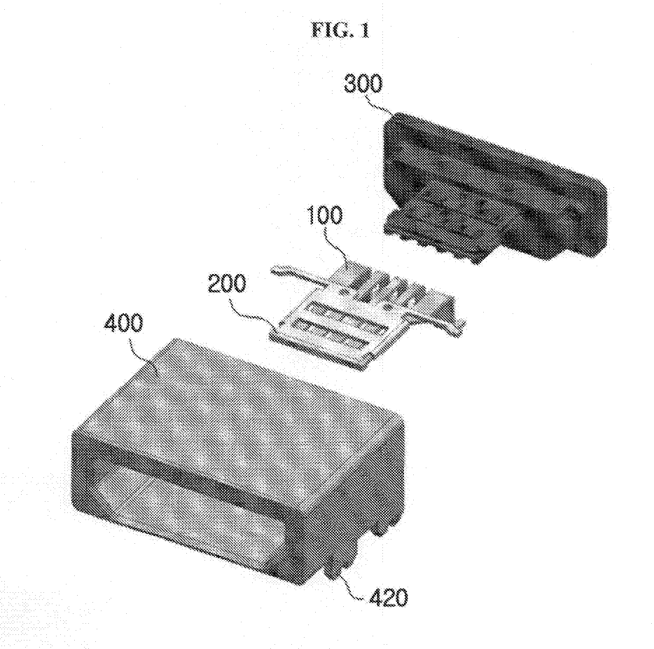

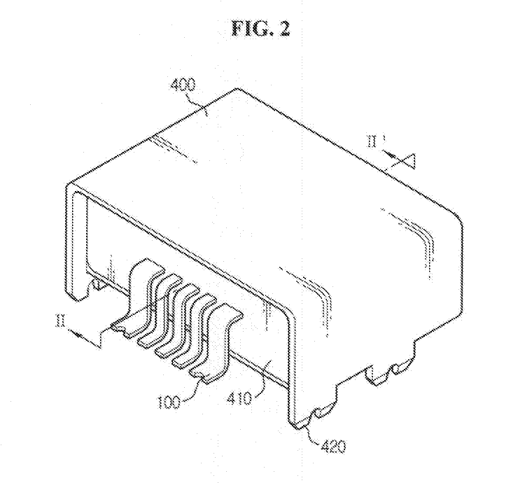

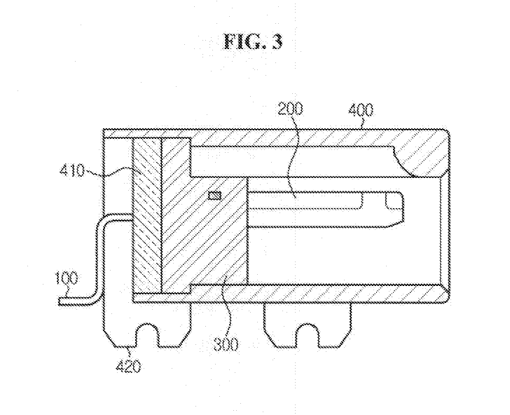

FIG. 1 is an exploded perspective view of a waterproof receptacle connector according to an embodiment of the present disclosure, FIG. 2 is an assembled perspective view of the waterproof receptacle connector according to an embodiment of the present disclosure, and FIG. 3 is a cross-sectional view of FIG. 2 taken along the line II-II′.

Referring to FIG. 1, the waterproof receptacle connector according to the present disclosure includes a plurality of contacts 100, a support plate 200, an insulator 300, and a shell 400.

The insulator 300 accommodates at least one contact 100 by an insert molding process. In this instance, the support plate 200 partially covering the contacts 100 to protect them is disposed on the contacts 100. In this case, after inserting and fixing the plurality of contacts 100 and the support plate 200 into a mold for insert molding, plastic resin is injected into the mold for insert molding to form the insulator 300 in which the plurality of contacts 100 is molded via insert molding. Here, the plurality of contacts 100 may be arranged, for example, to satisfy the pin standard of a general micro USB receptacle.

The insulator 300 having the plurality of contacts 100 inserted therein is inserted and received in the shell 400 through a rear surface side of the shell 400.

The shell 400 is formed in polygonal shape having upper and lower surfaces and left and right side surfaces to provide an internal space for receiving the insulator 300. Also, the shell 400 has a front side opening through which a plug connector (not shown) corresponding to the internal space is inserted.

For example, the shell 400 has a rectangular shape when viewed from the direction in which the plug connector is inserted.

Also, the shell 400 includes a holddown 420 that is formed integrally with the shell 400 and branched off on both sides of the bottom where contact with a printed circuit board takes place.

The holddowns 420 formed on both sides of the bottom of the shell 400 increase the mount strength of the shell 400 when soldered to the printed circuit board.

Although this embodiment describes that four holddowns 420 are spaced apart from each other, the present disclosure is not limited thereto.

The shell 400 has the upper, lower, left, and right surfaces processed with no hole or pore, except the front surface portion through which the plug connector is inserted and the rear surface portion through which the insulator 300 is inserted. Accordingly, the shell 400 can prevent the ingress of water from the outside per se without a separate component, so a separate component for removing a hole or a pore is not needed, resulting in a reduced mounting height of a product.

In this instance, the shell 400 may be processed by a die casting method or a metal injection molding (M.I.M) method.

The die casting method is a precision casting method which pours molten metal into a steel mold accurately machined to perfectly match the required casting shape, obtaining a cast product identical to the mold, and is also known as high pressure mold casting. The die casting method is widely used to mold aluminum, magnesium, zinc, and copper alloys, and is widely used to produce mobile phone components, electronic devices, and automobile components.

The metal injection molding method is a precision molding method for metal components, which mixes finely-powdered metal with resin and wax, and performs injection molding in a mold using an injection molding machine to manufacture a precision component of metal.

When the insertion of the insulator 300 in which the contacts 100 are received through the rear surface side is completed, an interruption portion 410 is formed on the rear surface of the shell 400.

Referring to FIGS. 2 and 3, the interruption portion 410 is formed by potting the rear surface of the insulator 300 that is inserted into the shell 400, to prevent water from entering an electronic device through a gap created when the insulator 300 and the shell 400 are assembled together.

The potting method for forming the interruption portion 410 is one method of encapsulating and packaging with plastic resin, and the rear surface of the insulator 300 received in the shell 400 may be closed by filling it with a liquid resin or viscous resin and curing the resin. Accordingly, it is possible to prevent water from entering an electronic device through a gap created when the insulator 300 and the shell 400 are assembled together, and prevent a malfunction in a product.

While the present disclosure has been hereinabove described by a limited number of embodiments and drawings, the present disclosure is not limited thereto and it should be understood that various changes and modifications may be made by those having ordinary skill in the art within the scope of the disclosure and the appended claims and their equivalents.

1. A waterproof receptacle connector comprising:
a plurality of contacts;
a support plate for partially covering and protecting the contacts;
an insulator on which the contacts are installed; and
a shell for containing the insulator on which the contacts are installed,
wherein the shell has upper, lower, left, and right surfaces processed with no hole or pore, except for a front surface portion through which a plug connector is inserted and a rear surface portion through which the insulator is inserted, and after the insulator is inserted through the rear surface portion of the shell, an interruption portion is formed on the rear surface.

2. The waterproof receptacle connector according to claim 1, wherein the shell is processed by a die casting method.

3. The waterproof receptacle connector according to claim 1, wherein the shell is processed by a metal injection molding (M.I.M) method.

4. The waterproof receptacle connector according to claim 1, wherein the shell includes a holddown integrally formed with the shell and branched off on both sides of a bottom where contact with a printed circuit board takes place.

5. The waterproof receptacle connector according to claim 1, wherein the interruption portion is formed by potting the rear surface after the insulator is inserted into the shell.

6. The waterproof receptacle connector according to claim 1, wherein the shell has a rectangular shape when viewed from a direction in which the plug connector is inserted.

7. The waterproof receptacle connector according to claim 5, wherein the interruption portion is formed by potting the entire rear surface of the insulator inserted in the shell.

8. The waterproof receptacle connector according to claim 5, wherein the interruption portion is formed by pouring liquid resin or viscous resin into the rear surface of the insulator received in the shell and curing the resin.

9. The waterproof receptacle connector according to claim 5, wherein the interruption portion is formed by potting to a lower end part of the rear surface portion of the shell spaced apart in a direction from the rear surface side of the shell to a front surface side, so that the interruption portion is disposed in a more inward direction than an upper side of the rear surface portion of the shell and at the lower end part of the rear surface portion of the shell.
